(19) United States
(12) Patent Application Publication
(10) Pub. No.: US 2015/0373399 A1
(43) Pub. Date: Dec. 24, 2015

(54) CONTROLLING DIGITAL AUDIO/VIDEO SEGMENT DURATION WITH REMAPPED TIME CODE

(71) Applicant: PRIME IMAGE DELAWARE, INC., Chalfont, PA (US)

(72) Inventors: Christopher Scott Gifford, Nipomo, CA (US); Keith William Schindler, Nipomo, CA (US)

(21) Appl. No.: 14/820,907

(22) Filed: Aug. 7, 2015

Related U.S. Application Data
(62) Division of application No. 13/623,351, filed on Sep. 20, 2012, now abandoned.
(60) Provisional application No. 61/538,342, filed on Sep. 23, 2011.

(51) Int. Cl. H04N 21/434; H04N 21/6336

(52) U.S. Cl. CPC H04N 21/4341; H04N 21/6336

(57) ABSTRACT

Methods and systems are provided for time altering one or more discrete digital audio/video program segments, each program segment having distinct In time and Out time code points. Data from the digital program segments are received from a data source and decoded. The decoded data are modulated as a serial data stream. The modulated decoded data are provided to a time altering processor to remove or duplicate frame positions to time alter the frame sequence. The resulting time altered serial data stream is demodulated to provide buffered program segment data. The buffered and time altered program segments are encoded and provided in a desired file or streaming format. Audio synchronization with the video is maintained by duplication or removal of audio samples corresponding to the duplicated or removed video frames.

### CROSS-REFERENCE

This application is a division of U.S. application Ser. No. 13/623,351, filed Sep. 23, 2012, which claimed the benefit of U.S. Provisional Patent Application No. 61/538,342, filed Sep. 23, 2011, and each of these applications is incorporated by reference in its entirety.

### TECHNICAL FIELD

The present invention relates generally to audio/video signal processing and, in particular, to methods and systems for broadcast and playout of video file mediation, including process control, decoding and modulation of digital video files for the purpose of altering the run time and correlative time code of an audio/video program signal or segment.

### BACKGROUND

Broadcast, production and editing workflows are quickly moving to media files versus uncompressed video on tape. Video servers provide playback and record capability, but do not have the ability to control and manage video modulation for the purpose of post-processing the audio/video program and remapping time altered time codes.

### SUMMARY

Methods and systems are provided for time altering one or more discrete digital audio/video program segments, each program segment having distinct In time and Out time code points. Data from the digital program segments are received from a data source and decoded. The decoded data are time modulated as a serial data stream. The modulated decoded data are provided to a time altering processor to remove or duplicate frame positions to time alter the frame sequence. The resulting time altered data stream is demodulated to provide buffered program segment data. The buffered and time altered program segments are encoded and provided as a desired file or streaming format. Audio synchronization with the video is maintained by duplication or removal of audio samples corresponding to duplicated or removed video frames. video frames.

The features and advantages of the various embodiments of the invention disclosed herein will be more fully understood and appreciated upon consideration of the following detailed description and the accompanying drawings, which set forth illustrative embodiments of the claimed subject matter.

### BRIEF DESCRIPTION OF THE DRAWINGS

FIG. 1 is a block diagram illustrating a compute module in association with a time processor.

FIG. 2 is a data flow diagram illustrating time alteration of one or more discrete digital audio/video program segments in accordance with the concepts of the present invention.

### DETAILED DESCRIPTION

Audio/video program segments contain associated time code, metadata or corresponding edit control lists that specify the “In” and “Out” time codes for each program segment. Control operations may be specified for each program segment where the following control modes may be applied to each In Point and/or Out Point.

1) Shift—Video segment In Points and Out Points may be offset by a constant amount in order to increase or decrease the “black hole” space between a neighboring segment where additional video content, such as for example commercial advertisements, may be inserted.

2) Trim—Video segment In Points and Out Points may be shifted individually in order to indicate video portions of a segment that are to be deleted when the time altered segments are created. This may be for the purpose of creating increased video content (e.g., commercial advertisement) space between segments.

3) Time Alter—Video segment In Points and Out Points may be repositioned individually in order to compress or expand a video time segment in time.

4) Preferred or Non-Preferred and Held Time Altering Regions—Regions within video segments may be specified where frame dropping or frame duplication for the purpose of time alteration is either preferred or non-preferred or held. When a region is specified as “hold” control, then time alteration may not occur within that region.

Various control modes may be combined in order to produce the desired effects. For example, a second segment's In Point is shifted away from a first segment in order to increase video content (e.g., commercial advertisement) space between the segments, but then the Out Point of the second segment may be time altered in order to compress the second segment so that the final time code of the Out Point of the second segment did not change from the original Out Point. In another example, a segment's Out Point is shifted in order to significantly compress the segment, but a region of the segment that contains critical motion is specified on “hold” mode so that the compression process does not produce undesirable artifacts during the held region of the segment.

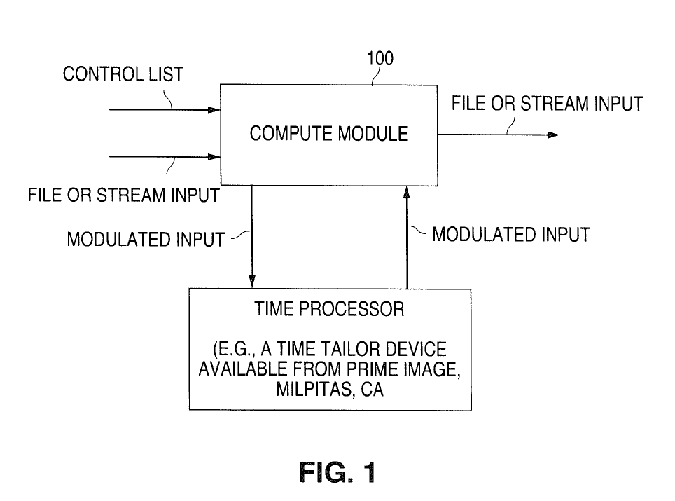

FIG. 1 shows a compute module 100 and an associated time processor 102. The time processor 102 may be, for example, a Time Tailor time processor available from Prime Image, Chalfont, Pa. Please see U.S. Pat. No. 5,995,153, which is hereby incorporated by reference herein in its entirety to provide background information regarding the present invention. Please also see U.S. Pat. No. 7,092,774, which is incorporated by reference herein in its entirety to provide background information regarding the present invention.

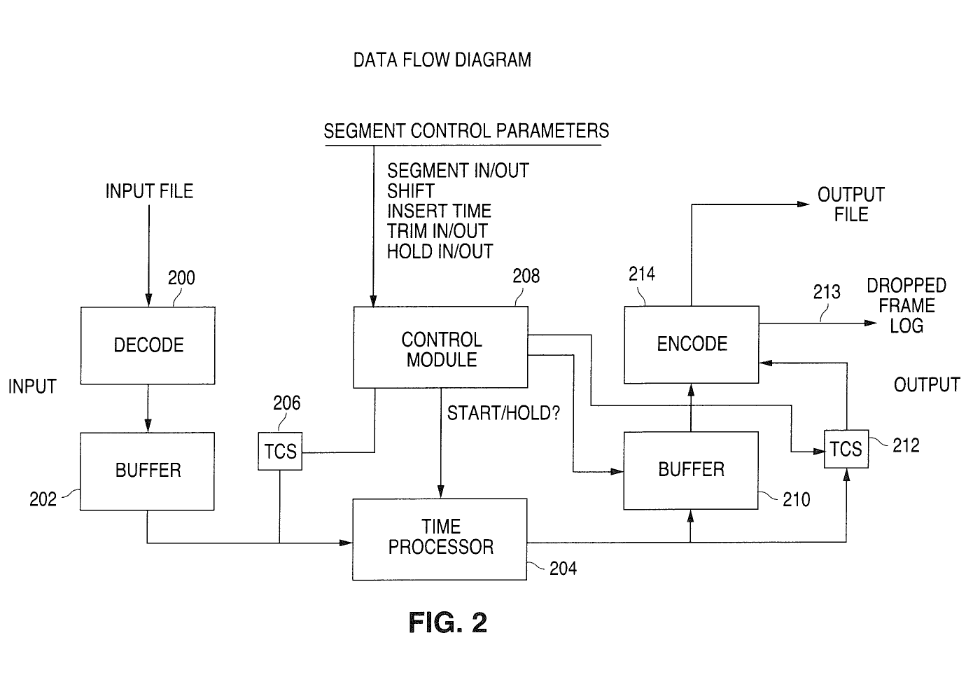

FIG. 2 shows a data flow diagram for altering one or more discrete digital audio/video segments of an audio/video signal.

As shown in FIG. 2, for each segment of the audio/video file or stream, a decode device 200 decodes the segment into a frame buffer 202. The Insert Time and Total Program Time for the segment are set in the Time Processor 204 such that TCout[0]=TCin[0]+Shift, where TCout[0] is the time code of the first frame in output and TCin[0] is the time code of the first frame in input. The input buffer of frames is then modulated by associating sequential time code 206 received from the control module 208 starting at Segment In and ending at Segment Out.

For each input frame of the segment, if it is a “Trim” frame, then neither the output buffer 210 nor the output time code 212 are advanced when the processed frame is received. If the frame is the first “Time Compressed” frame, then a Start Command is issued to the Time Processor 204. If the frame is the first “Hold” frame after Time Compression is started, then the Time Processor 204 is put in Hold mode. If the frame is the last “Hold” frame, then the Time Processor Hold mode is ended. If the time code received from the Time Processor 204 is the previous time code +2, then the input time code is entered into the dropped frame log 213. The output time code is then mapped to the previous time code +1, unless in the “Trim” mode.

After each frame is processed, an encode device 214 encodes the output frame to the output file or stream.

The following provides an example of input segment processing:

Input Segment:

| | | | |
|---|---|---|---|
| In Point | 00:01 00:00 | Out Point | 00:45 30:00 |

Insert 30 second space before segment (Shift 30:00)
Trim 10 seconds, from 00:01 00:00 to 00:01 10:00
Time Compress segment from 00:01 10:00 to 00:45 30:00 by dropping 20
seconds
Hold time processing (no dropped frames) between 00:20 40:00 to 00:30
20:00

Resulting Output Segment:

| | | | |
|---|---|---|---|
| In Point | 00:01 00:00 | Out Point | 00:45 30:00 |

| Input | Output | |
|---|---|---|
| 00:01 00:00 | 00:01 30:00 | :Shift |
| 00:01 10:00 | 00:01 30:00 | :Trim |
| 00:01 10:01 | 00:01 30:01 | :Time Compress - not dropped |
| 00:01 10:02 | 00:01 30:01 | :Time Compress - dropped frame |
| 00:01 10:03 | 00:01 30:02 | :Time Compress - not dropped |
| — | — | |
| — | — | :Dropped 12:25 select frames |
| — | — | |
| 00:20 39:29 | 00:20 47:03 | :Time Compress - not dropped |
| 00:20 40:00 | 00:20 47:04 | :Held |
| — | — | |
| — | — | :Held from Time Compress, 9:40 00 |
| 00:30 20:00 | 00:30 27:04 | :Held |
| — | — | |
| — | — | :dropped 07:05 select frames |
| 0045 30:00 | 00:45 30:00 | :Time Compress, not dropped |

Thus, in accordance with embodiments of the invention, a digital audio/video program that includes one or more discrete program segments is cached, decoded and modulated by a Control Module, then passed to Time Processor (e.g., a Time Tailor processor available from Prime Image, Chalfont, Pa.) which alters the duration of the program segments based upon a list of control parameters specified for each segment. The time duration altering process produces dropped or duplicated frames that would otherwise disrupt the original linear progression of time code of each segment that is time altered. In producing the time-altered program segments, the time code is remapped to establish a linear, sequential progression from start to end of each program segment. The original program material is cached to a raw file-based format and may be reprocessed any number of times after editing adjustments are made to alter program segment start and end times, specifying increased or decreased offsets between segment breaks (increasing or decreasing “black holes” for, for example, commercial advertisements), specifying new segment break points, or specifying segment regions that are preferred for frame dropping or duplication, or specifying segment regions that are not preferred (“Held”) from frame dropping or duplication.

The modulated time altered program segments produced by the Time Processor are then fed back to the Compute Module where they are demodulated and encoded to the desired format along with the newly mapped time code. Output program segments may be optionally reviewed on a monitor for evaluation with a user interface, thereby allowing an operator to fine tune segment control settings on a next editing pass.

Digital program material may be ingested into the system in either file-based or streaming format. Time altered program segments may be output from the system in either streaming or file-based format.

Those skilled in the art will appreciate that audio synchronization with the video may be maintained by duplicating or removing an appropriate number of audio samples corresponding to the duplicated or removed video frames

It should be understood that the particular embodiments of the subject matter described above have been provided by way of example and that other modifications may occur to those skilled in the art without departing from the scope of the claimed subject matter as expressed by the appended claims and their equivalents.

1. A method of time altering at least one discrete program segment of an audio/video program signal, the duration of the each discrete program segment specified by time codes including a start time and an end time, the method comprising:
decoding the discrete program segment;
modulating the decoded discrete program segments-as a serial data stream having the specified time codes;
processing the modulated serial data stream to modify at least one of the time codes on the basis of at least one control parameter;
demodulating the modulated serial data stream with the modified time codes; and
encoding the demodulated serial data stream into a modified discrete program segment having the modified time codes.

2. The method of claim 1, further comprising:
caching the-audio/video program signal to storage; and
performing the method of claim 13 over a plurality of iterations such that control parameters may be selected over several iterations.

3. The method of claim 1, further comprising:
providing, via the control parameter, an offset to the start time or the end time of the discrete program segment in order to alter the time spacing with an adjacent discrete program segment.

4. The method of claim 1, further comprising:
shifting, via the control parameter, the start time or the end time of a discrete program segment in order to compress or expand the discrete program segment.

5. The method of claim 1, further comprising:
specifying, via the control parameter, regions of the discrete program segment that are preferred for time alteration, not preferred for time alteration, or prohibited for time alteration.

6. The method of claim 1, further comprising:
remapping the time codes from the start time to the end time of the modified discrete program segment.

7. A system for time altering at least one discrete-program segment of an audio/video program signal, the discrete program segment having time codes including a start time and an end time, comprising:
a control module configured to decode the discrete program segment, to modulate the decoded discrete program segment as a serial data stream having the time codes, to pass the modulated serial data stream to a time alteration processor, to receive a time altered serial data stream from time alteration processor, to demodulate the time altered serial data stream, and to encode the demodulated time altered serial data stream as a modified discrete program segment; and
a time alteration processor for modifying at least one of the time codes of the modulated serial data stream on the basis of at least one specified control parameter in order to generate a time altered serial data stream.

8. The system of claim 7, further comprising:
a storage device for caching the audio/video program signal segments for processing discrete program segments over multiple sessions.

9. The system of claim 7, further comprising:
a first control interface for specifying an offset to the start time or the end time of the discrete program segment in order to alter the time spacing with regard to an adjacent program segment.

10. The system of claim 7, further comprising:
a second control interface for specifying how much to shift the start time or the end time of the discrete program segment in order to compress or expand the discrete program segment.

11. The system of claim 7, further comprising:
a third control interface for specifying regions of the discrete program segment that are preferred for time alteration, not preferred for time alteration, or prohibited for time alteration.

12. The system of claim 7, wherein the time alteration processor remaps the time codes for the modified discrete program segment.

13. The method of claim 1, further comprising:
synchronizing an audio portion of the audio/video program signal with the modified discrete program segment.

14. The method of claim 7, further comprising:
the time alteration processor maintaining audio synchronization with the modified discrete program segment.

15. A method for altering the duration of at least one discrete segment of an audio/video program signal, the duration of each discrete segment specified by time codes including a start time and an end time, the method comprising:
decoding the discrete segment into a serial data stream having the specified time codes;
specifying at least one control parameter for operating on at least one time code of the serial data stream to generate modified time codes;
modulating the serial data stream with the modified time codes; and
demodulating and encoding the modulated serial data stream into a modified discrete segment having the modified time codes.

16. The method of claim 15, the control parameter including an offset to the start time or the end time of the discrete segment, whereby the offset causes an increase or a decrease in a space between adjacent discrete segments.

17. The method of claim 15, the control parameter including a shift to the start time or the end time of the discrete segment, whereby the shift identifies portions of the discrete segment to be deleted.

18. The method of claim 15, the control parameter including a repositioning of the start time or the end time of the discrete segment, whereby the repositioning causes a compression or a expansion of the duration of the discrete segment.

19. The method of claim 15, the control parameter including information concerning regions of the discrete segment that are preferred for time alteration, not preferred for time alteration, or prohibited for time alteration.
